(19) United States
(12) Patent Application Publication
(10) Pub. No.: US 2020/0318390 A1
(43) Pub. Date: Oct. 8, 2020

(54) COMBINATION LOCK

(71) Applicant: MASTER LOCK COMPANY LLC, OAK CREEK, WI (US)

(72) Inventor: ANDREW DAVID BARTEL, FRANKLIN, WI (US)

(73) Assignee: MASTER LOCK COMPANY LLC, OAK CREEK, WI (US)

(21) Appl. No.: 16/761,986

(22) PCT Filed: Nov. 2, 2018
(86) PCT No.: PCT/US2018/058842

§ 371 Date: May 6, 2020

Related U.S. Application Data
(60) Provisional application No. 62/583,722, filed on Nov. 9, 2017.

(51) Int. Cl. E05B 37/00; E05B 37/02; E05B 37/10

(52) U.S. Cl. CPC E05B 37/0055; E05B 37/10; E05B 37/025

(57) ABSTRACT

A combination lock includes a lock body, a shaft secured within the lock body, and a plurality of coaxially aligned rotary lock elements rotatable about the shaft. Each rotary lock element includes an inner peripheral hub disposed on the shaft and including a radial bore extending from an outer periphery of the hub to an inner periphery of the hub, and an outer peripheral wheel surrounding the hub. A shaft engaging member a wheel engaging member are disposed in the radial bore, with the wheel engaging member extending partially outward of the outer periphery of the hub for engagement with one of a plurality of inner peripheral pockets in the wheel to rotationally fix the wheel with the hub. When the locking shaft is moved from a normal operating position to a code change position, the shaft engaging member of each dial is partially receivable in a corresponding recess in the locking shaft, and the wheel engaging member is receivable into the radial bore to rotationally disengage the wheel from the corresponding hub.

### CROSS-REFERENCE TO RELATED APPLICATION

This application claims the benefit of U.S. Provisional Application No. 62/583,722, filed Nov. 9, 2017, the entire disclosure of which is hereby incorporated by reference.

### BACKGROUND

Combination locks are used in commercial, residential, and institutional environments to provide lockable access to personal items and/or enclosures. The combination lock may be a separate device, such as a combination padlock, which may be shackled to a door, bracket, cable, or other item to restrict access. Alternatively, the combination lock may be integral to an enclosure, such as a safe or a storage locker. Combination locks include single-dial and multiple-dial designs.

### SUMMARY OF THE DISCLOSURE

In an exemplary embodiment of the present application, a combination lock includes a lock body, a locking shaft secured within the lock body, and a plurality of coaxially aligned dials rotatable about the locking shaft. Each of the plurality of dials includes a user graspable outer peripheral wheel, an inner peripheral hub longitudinally aligned and interlocking with the corresponding wheel, and a shaft engaging portion blocking longitudinal movement of the locking shaft. When each of the plurality of dials is rotated to an unlocking orientation, each of the shaft engaging portions is disengageable from the locking shaft to permit longitudinal movement of the locking shaft. The lock includes a code change mechanism configured to disengage each of the plurality of wheels from the corresponding hubs while maintaining longitudinal alignment of the wheels and hubs, to permit rotation of each wheel with respect to the corresponding hub.

In another exemplary embodiment of the present application, a combination lock includes a lock body, a locking shaft secured within the lock body, and a plurality of coaxially aligned dials rotatable about the locking shaft. Each of the plurality of dials includes a shaft engaging member received in a corresponding annular groove around the locking shaft to block longitudinal movement of the locking shaft while permitting rotation of the dial around the locking shaft. When each of the plurality of dials is rotated to an unlocking orientation, each of the shaft engaging members aligns with a longitudinal groove in the locking shaft to permit longitudinal movement of the locking shaft with respect to the plurality of dials.

In another exemplary embodiment of the present application, a combination lock includes a lock body, a locking shaft secured within the lock body, and a plurality of coaxially aligned dials rotatable about the locking shaft. Each of the plurality of dials includes an inner peripheral hub disposed on the locking shaft and including a radial bore extending from an outer periphery of the hub to an inner periphery of the hub, and a user graspable outer peripheral wheel surrounding the hub. A shaft engaging member is disposed in the radial bore and extends partially inward of the inner periphery of the hub for engagement with an annular groove in the locking shaft, to permit rotation of the hub about the locking shaft. A wheel engaging member is disposed in the radial bore and extends partially outward of the outer periphery of the hub for engagement with one of a plurality of inner peripheral pockets in the wheel to rotationally fix the wheel with the hub. When each of the plurality of dials is rotated to an unlocking orientation, the locking shaft is moveable from a locked position to either one of an unlocking position and a code change position. When the locking shaft is moved to the code change position, the shaft engaging member of each dial is partially receivable in a corresponding recess in the locking shaft to rotationally fix the corresponding hub with the locking shaft, and the wheel engaging member is fully receivable into the radial bore to permit rotation of the wheel with respect to the corresponding hub.

In another exemplary embodiment, a combination lock includes a lock body, a shaft secured within the lock body, and a plurality of coaxially aligned rotary lock elements rotatable about the shaft. Each rotary lock element includes an inner peripheral hub disposed on the shaft and including a radial bore extending from an outer periphery of the hub to an inner periphery of the hub, and an outer peripheral wheel surrounding the hub. A shaft engaging member and a wheel engaging member are disposed in the radial bore, with the wheel engaging member extending partially outward of the outer periphery of the hub for engagement with one of a plurality of inner peripheral pockets in the wheel to rotationally fix the wheel with the hub. When the locking shaft is moved from a normal operating position to a code change position, the shaft engaging member of each dial is partially receivable in a corresponding recess in the locking shaft, and the wheel engaging member is receivable into the radial bore to rotationally disengage the wheel from the corresponding hub.

### BRIEF DESCRIPTION OF THE DRAWINGS

Further features and advantages of the invention will become apparent from the following detailed description made with reference to the accompanying drawings, wherein:

FIG. 1 is a front perspective view of a combination lock, according to an exemplary embodiment of the present application;

FIG. 2 is a rear perspective view of the combination lock of FIG. 1;

FIG. 3 is an exploded upper perspective view of the combination lock of FIG. 1;

FIG. 4 is a front cross-sectional view of the combination lock of FIG. 1, shown in the locked condition;

FIG. 4A is an upper cross-sectional view of a dial subassembly of the combination lock of FIG. 1, shown in the locked condition;

FIG. 5 is a front cross-sectional view of the combination lock of FIG. 1, shown in the unlocked condition;

FIG. 5A is an upper cross-sectional view of a dial subassembly of the combination lock of FIG. 1, shown in the unlocked condition; and

FIG. 6 is a front cross-sectional view of the combination lock of FIG. 1, shown in the code change condition;

FIG. 6A is an upper cross-sectional view of a dial subassembly of the combination lock of FIG. 1, shown in the code change condition;

FIG. 7 is a side perspective view of the locking shaft of the combination lock of FIG. 1;

FIG. 8 is an upper perspective view of a wheel of the combination lock of FIG. 1;

FIG. 9 is a lower perspective view of a hub of the combination lock of FIG. 1;

FIG. 9A is a lower perspective view of another hub for a combination lock, in accordance with another exemplary embodiment;

FIG. 10 is an upper perspective view of the button of the combination lock of FIG. 1;

FIG. 11 is a front perspective view of a combination lock, according to another exemplary embodiment of the present application;

FIG. 12 is a rear perspective view of the combination lock of FIG. 11;

FIG. 13A is a front exploded perspective view of the combination lock of FIG. 11;

FIG. 13B is a rear exploded perspective view of the combination lock of FIG. 11;

FIG. 14 is a side cross-sectional view of the combination lock of FIG. 11, shown in the unlocked condition;

FIG. 14A is a rear cross-sectional view of the combination lock of FIG. 11, shown in the unlocked condition;

FIG. 15 is a side cross-sectional view of the combination lock of FIG. 11, shown in the code change condition; and

FIG. 15A is a rear cross-sectional view of the combination lock of FIG. 11, shown in the code change condition.

### DETAILED DESCRIPTION

The present application relates to combination lock arrangements that may be used with many different types of locks, such as, for example, combination padlocks, safe locks, and integral locks for lockers, mailboxes, storage sheds, or other such structures and enclosures. While the embodiments described in the present application refer to a multiple-dial combination padlock, the inventive aspects described herein may be applied to any type of lock incorporating any number of combination dials. This Detailed Description merely describes exemplary embodiments and is not intended to limit the scope of the claims in any way. Indeed, the invention as claimed is broader than and unlimited by the described embodiments, and the terms used have their full ordinary meaning.

The present application contemplates a locking mechanism including a plurality of coaxially aligned rotatable dials rotatable about a locking shaft. The locking arrangement is configured such that when at least one of the dials is misaligned with its unlocking orientation, sliding movement of the locking shaft is blocked or prevented. When each of the plurality of dials is rotated to an unlocking orientation, the locking shaft is longitudinally movable to unlock the locking mechanism (e.g., to release a shackle, slide a locking bolt, etc.).

Many different dial-shaft interlocking arrangements may be utilized. In one embodiment, each dial subassembly includes a shaft engaging member received in a corresponding annular groove around the locking shaft to block longitudinal sliding movement of the locking shaft while permitting rotation of the dial subassembly around the locking shaft. The locking shaft includes longitudinally extending grooves that intersect with the annular grooves. When each of the plurality of dials is rotated to an unlocking orientation, each of the shaft engaging members aligns with a corresponding longitudinally extending groove to permit longitudinal movement of the locking shaft with respect to the dials.

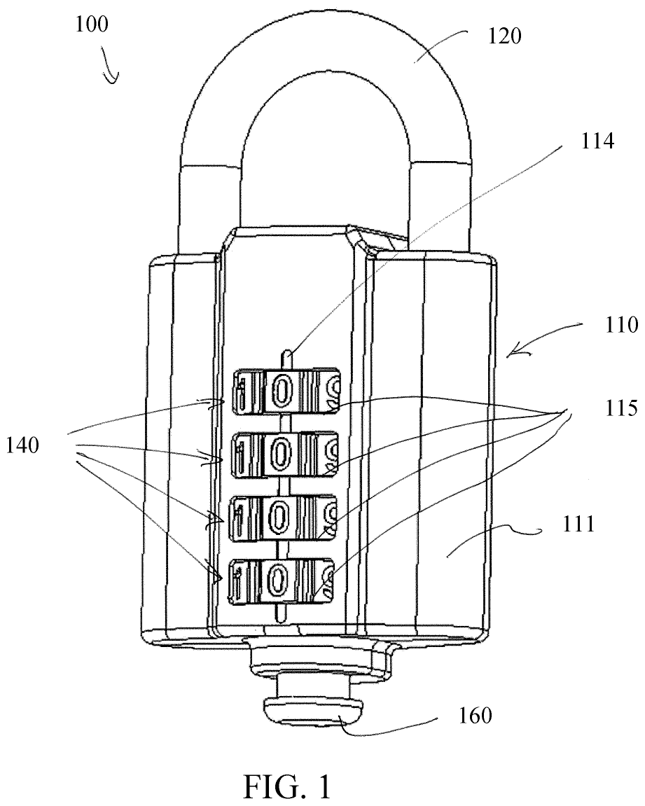

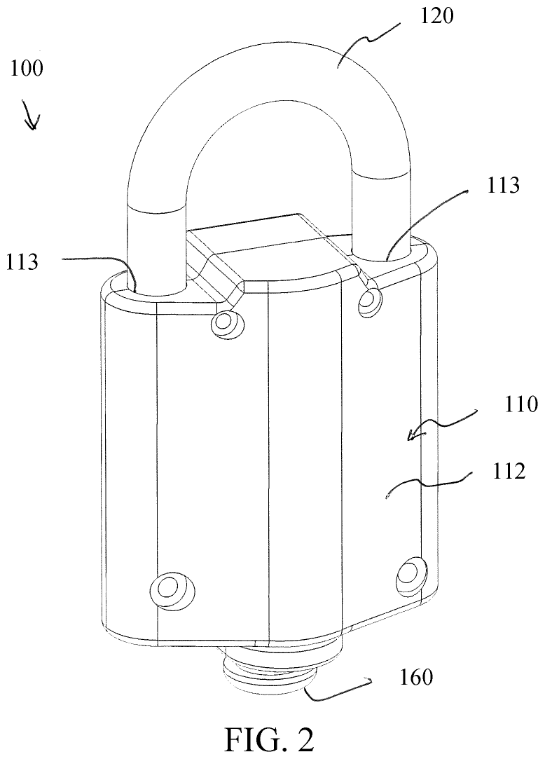

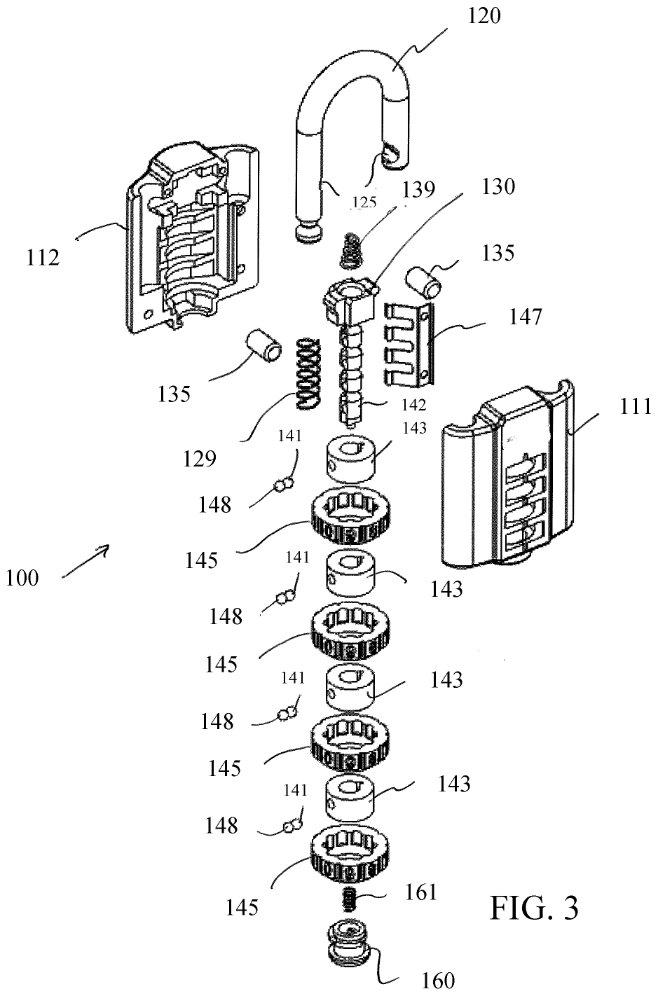

Referring now to the drawings, FIGS. 1-6 illustrate an exemplary embodiment of a multiple-dial combination padlock 100. The exemplary padlock 100 includes a lock body 110, a shackle 120 secured with the lock body (through shackle bores 113 in the upper end of the lock body), and a series of dials 140, partially exposed through openings 115 in the lock body 110 to allow user grasping and rotation of the dials 140. The exemplary lock body 110, as shown in the exploded view of FIG. 3, includes front and rear housing members 111, 112, which are joined and secured together (e.g., using rivets, bolts, welding, or other fastening arrangements) to define cavities within the lock body for accommodating the internal components of the lock 100.

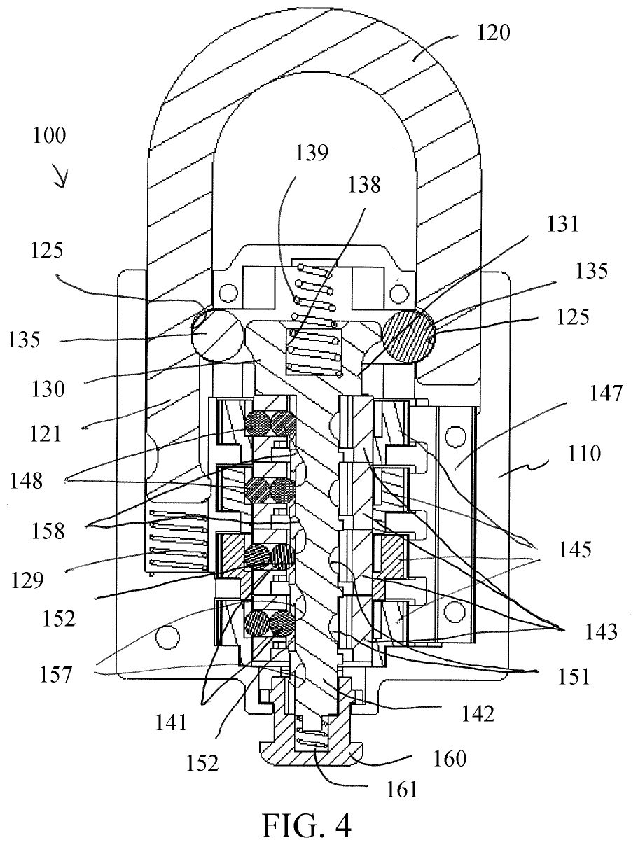

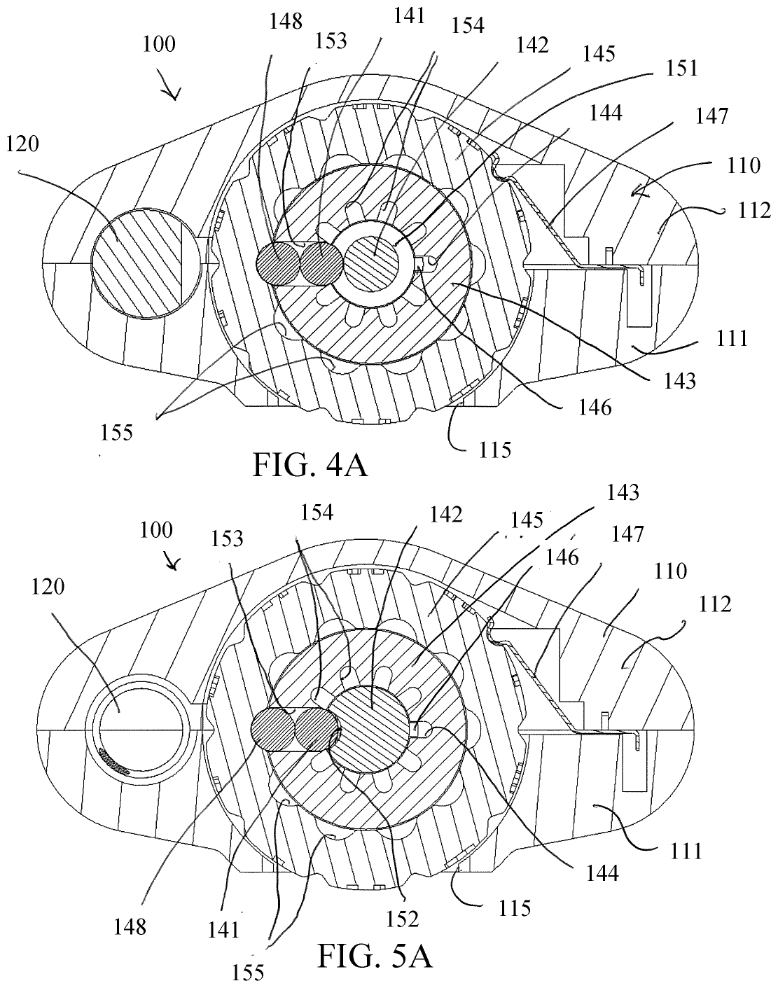

The exemplary lock 100 includes a locking mechanism, discussed in greater detail below, that releases the shackle 120 from a locked condition when each of the dials 140 is rotated to an unlocking orientation. While the illustrated dials 140 include number markings to identify the rotational orientation of each wheel, any types of markings may be used (including, for example, letters, pictures, and colors). While many different locking mechanisms may be employed, in the illustrated embodiment, the shackle 120 is secured in a locked condition within the lock body 110 by a sliding blocker 130, which forces locking members 135 (e.g., balls, pins) into engagement with corresponding notches 125 (as shown in FIG. 4) in the shackle 120 when the blocker 130 is in a locked position, thereby preventing longitudinal movement of the shackle 120. When at least one of the dials 140 is misaligned with its unlocking orientation, movement of the blocker 130 out of the locked position is prevented. When all of the dials are in their unlocking orientations, the blocker is permitted to slide longitudinally from the locked position to the unlocking position, allowing the locking members 135 to retract from the shackle notches 125 for release of the shackle, permitting longitudinal movement of the shackle to an open position. As shown, a compression spring 129 (or other such biasing feature) may be provided under the long shackle leg 121 for automatic movement of the shackle to the open position when the blocker 130 is moved to the unlocking position.

Each dial 140 includes a wheel 145 and hub 143 joined as a dial subassembly for co-rotation about a locking shaft 142. The dial subassemblies 140 may be longitudinally fixed within the lock body 110, for example, by retention with the lock body openings 115. The lock 100 may further include a spring detent plate 147 (see FIG. 3) to hold the dials 140 in place in one of several set positions (for example, the numbered “0” through “9” positions on a conventional lock dial, for alignment with visible indicia 114 on the lock body) when the dials are not being manually rotated by a user.

Each dial subassembly 140 includes a shaft engaging portion or shaft engaging member 141 (e.g., a ball bearing, as shown) extending radially inward of an inner periphery of the hub 143 for engagement with an annular groove 151 in the locking shaft 142, to allow for rotation of the dial subassembly 140 about the locking shaft while blocking longitudinal movement of the locking shaft with respect to the dials. The locking shaft includes longitudinally extending grooves 152 that intersect with the annular grooves 151. When each of the dials 140 is rotated to an unlocking orientation, each of the shaft engaging members 141 aligns with a corresponding longitudinally extending groove 152 to permit longitudinal movement of the locking shaft 142 with respect to the dials 140, as will be described in greater detail below. The exemplary locking shaft is integral with (e.g., monolithically formed, welded, mechanically attached) the blocker 130 for movement of the blocker with the locking shaft from the locked position to the unlocking position when the dials are in the unlocking orientation.

Many different arrangements may be utilized to move the locking shaft from the locked position to the unlocking position. In the illustrated embodiment, a button 160, operatively connected with the locking shaft 142, is provided on the bottom of the lock body 110. When the combination dials are in the unlocking orientation, the button may be pressed to slide the locking shaft 142 and blocker 130 longitudinally upward to an unlocking position, to align a narrowed or necked down portion 131 of the blocker 130 with the locking members 135, to permit retraction of the locking members 135 from the shackle notches 125. As shown, the button may be spring-biased (e.g., by spring 161) into an un-pressed position.

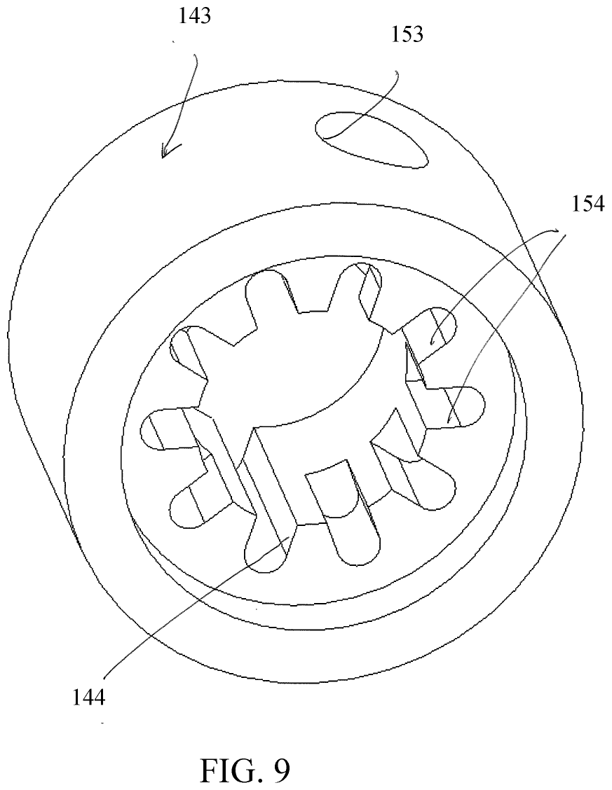

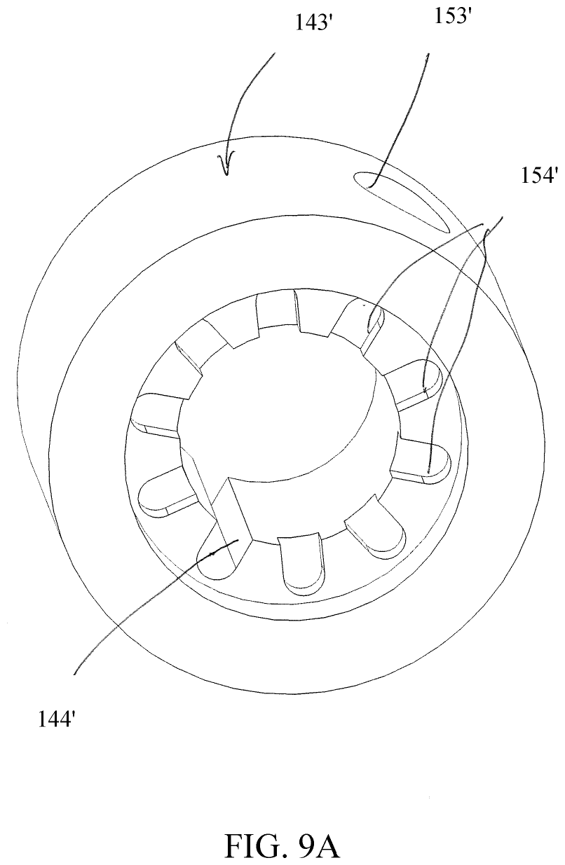

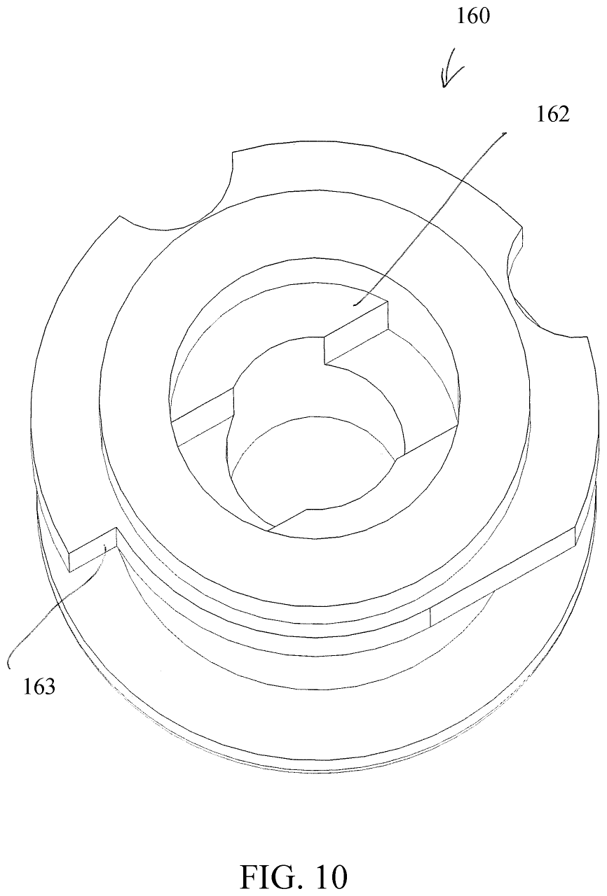

In the illustrated embodiment of FIGS. 1-6, the inner periphery of each hub 143 is provided with a longitudinally extending slot 144, and the locking shaft 142 is provided with a corresponding rib 146, longitudinally offset from the hub 143 when the locking shaft 142 is in the locked position, the rib 146 being received in the slot 144 when the hub 143 is in the unlocking orientation and the locking shaft 142 is moved to the unlocking position. As shown, the hub 143 may also be provided with an array of notches 154 that align with the rib 146 when the dial is in any of the locked orientations. Engagement of the rib 146 with any of these notches 154 may provide a false indication of the unlocking orientation of the dial, to make picking of the lock 100 more difficult. These notches may be formed to extend to a variety of depths in the hub, including, for example, through the entire length of the hub (not shown), like the slot 144. In the illustrated embodiment, as shown in FIG. 9, the notches 154 extend far enough into the hub 143 that movement of the locking shaft 142 to the unlocking position is not blocked by engagement of the rib 146 with the base of the hub notch 154 when the dial is in a locked orientation. In an alternative embodiment, as shown in FIG. 9A, the notches 154′ in the hub 143′ may be shallow enough for the rib-notch inter-engagement to block longitudinal movement of the locking shaft to the unlocking position when the dial is in a locked orientation, while still providing false indication of alignment of the rib with the slot to impede lock picking, thereby functioning as an additional, or secondary, locking feature. Additionally, the rib and slot may be more precisely sized to require precise orientation of the dials to unlock the locking mechanism.

To unlock the exemplary padlock 100, the dials 140 are rotated into orientations corresponding with the current unlocking combination code, such that each of the shaft engaging members 141 aligns with a corresponding longitudinal groove 152 of the locking shaft 142, and each of the slots 144 aligns with a corresponding shaft rib 146. The button 160 is depressed to longitudinally move the locking shaft 142 and integral blocker 130 to the unlocking position. With the narrowed portion 131 of the blocker 130 aligned with the locking members 135, the biasing force (by spring 129) on the long shackle leg 121 forces the locking members 135 out of engagement with the shackle notches 125, and the shackle 120 into the open position. With the shackle in the open position, the locking members 135, blocked from outward lateral movement by the lower portion of the long shackle leg 121, secure the locking shaft 142 and blocker 130 in the unlocking position, and retention of the shaft engaging members 141 in the longitudinal grooves 152 secures the dials 140 in their unlocking orientation. When the shackle 120 is returned to the closed position, such that the shackle notches 125 align with the locking members 135, a blocker spring 139, seated in an upper bore 138 of the blocker, moves the blocker 130 and locking shaft 142 back to the locked position, with the locking members 135 re-engaging the shackle notches 125.

According to another aspect of the present application, dial subassemblies may be configured to permit disengagement of the wheels 145 from the hubs 143, such that the orientation of the wheel 145 (and its indicia) may be adjusted with respect to the shaft engaging member 141, such that a different wheel indicium corresponds to the unlocking orientation of the dial, to change the unlocking combination code of the lock. Many different arrangements may be provided for selective wheel-hub disengagement. In some embodiments, the hubs may be longitudinally displaced from the wheels for disengagement, for example, by longitudinally fixing the hubs with the locking shaft and longitudinally moving the locking shaft and hubs to a code change position. In other embodiments, a wheel engaging member may be assembled with the wheel and hub in the dial subassembly, with the wheel engaging member being movable to a wheel releasing position to disengage the wheel from the hub when a code change mechanism of the lock is operated. In one such embodiment, disengagement of the wheel from the hub may coincide with rotational interlocking of the hub with the locking shaft, thereby securing the hub in a fixed rotational position while the wheel is being adjusted.

In the illustrated embodiment of FIGS. 1-6, a radially extending bore 153 in each hub 143 retains an outer bearing or wheel engaging member 148 (e.g., a ball bearing, as shown) and an inner bearing or shaft engaging member 141 (e.g., a ball bearing, as shown). The wheel engaging member 148 extends radially outward from the hub bore 153 for engagement with one of a series of pockets 155 around an inner periphery of the wheel 145, to interlock the wheel 145 with the hub 143. The shaft engaging member 141 extends radially inward from the hub bore 153 for engagement with the annular groove 151 (when in the locked position) or the longitudinal groove 152 (when in the unlocked position) in the locking shaft 142. To simultaneously disengage the wheel 145 from the hub 143 and rotationally fix the hub 143 with the locking shaft 142, the locking shaft 142 includes recesses 157 that align with the shaft engaging members 141 when the locking shaft is moved to a code change position. In this code change position, rotation of any of the wheels 145 pushes the wheel engaging member 148 radially inward into the hub bore 153, and the shaft engaging member 141 radially inward and partially into the shaft recess 157, such that the wheel 145 is disengaged from the hub 143 and the hub is rotationally fixed with the shaft 142.

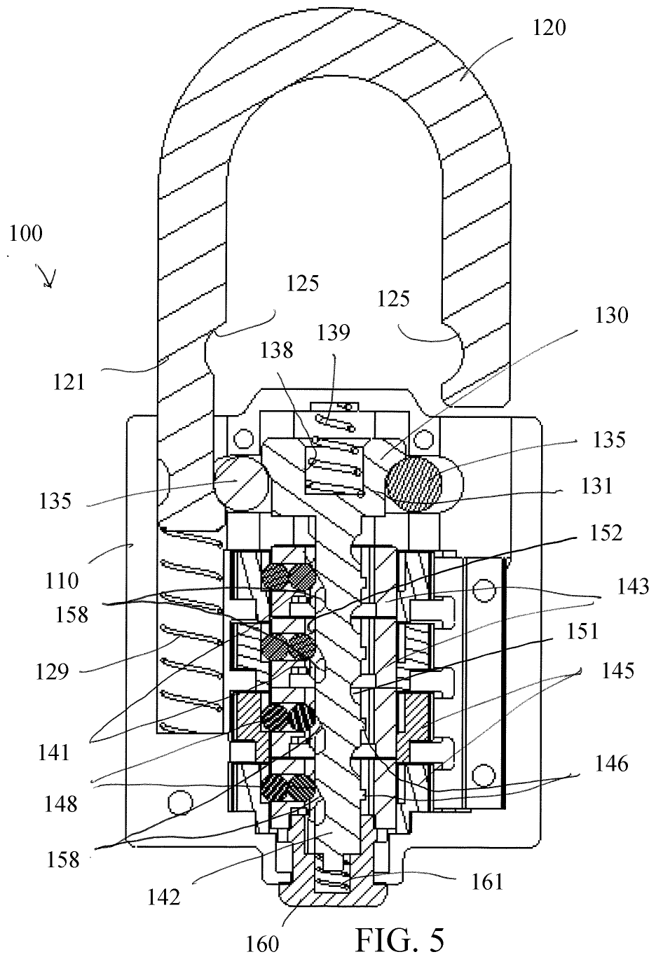

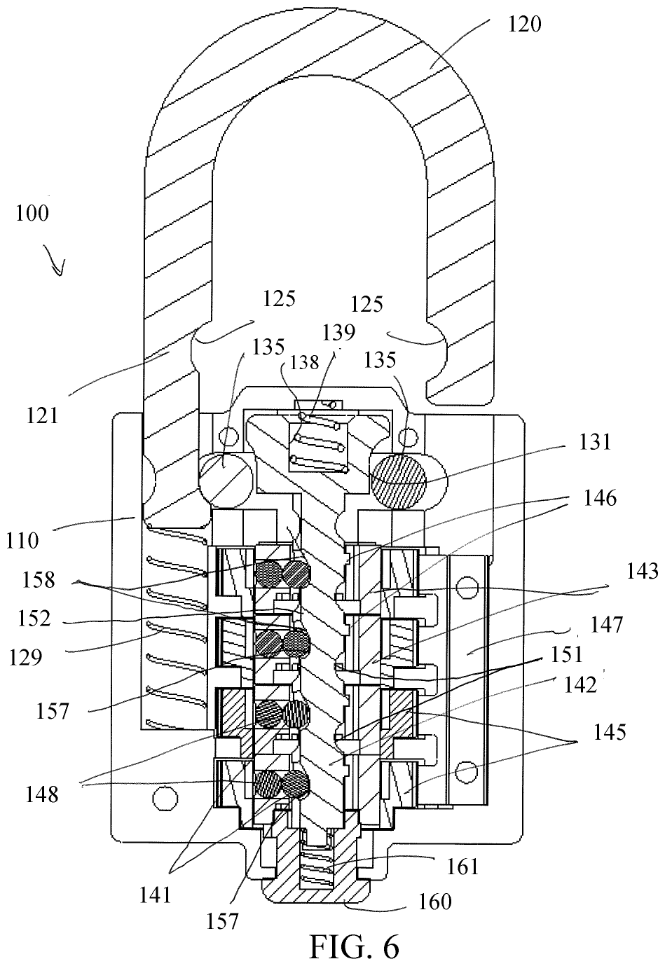

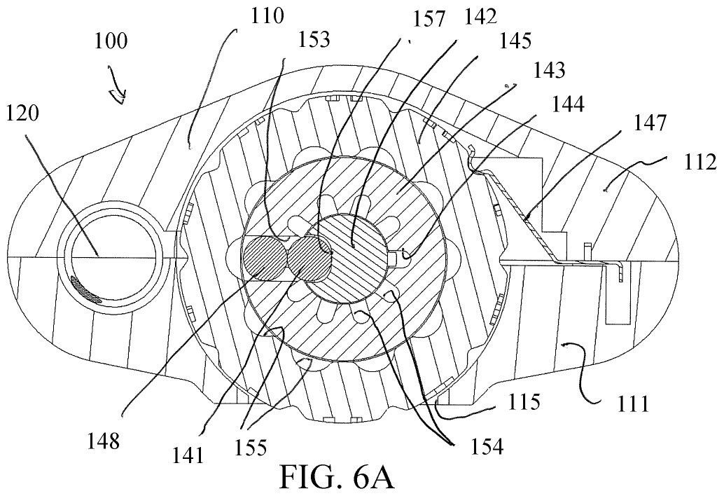

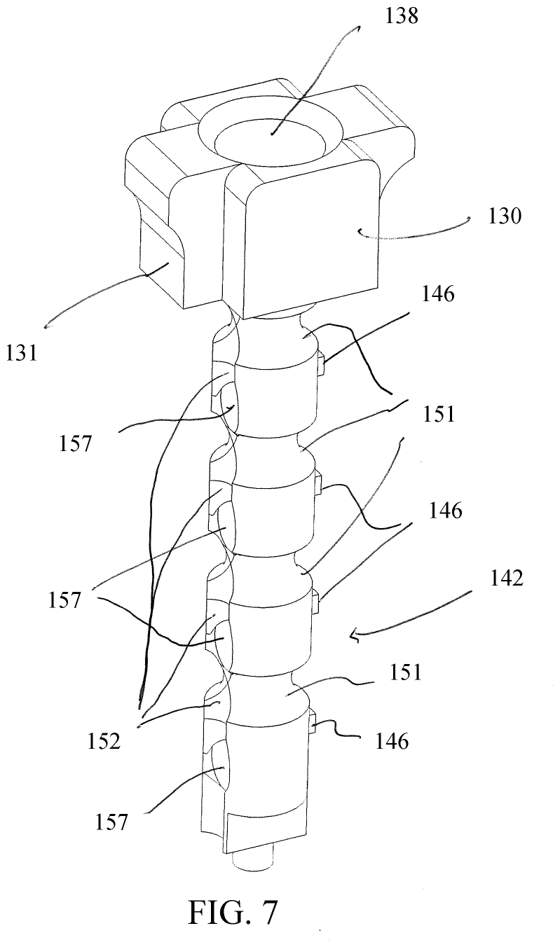

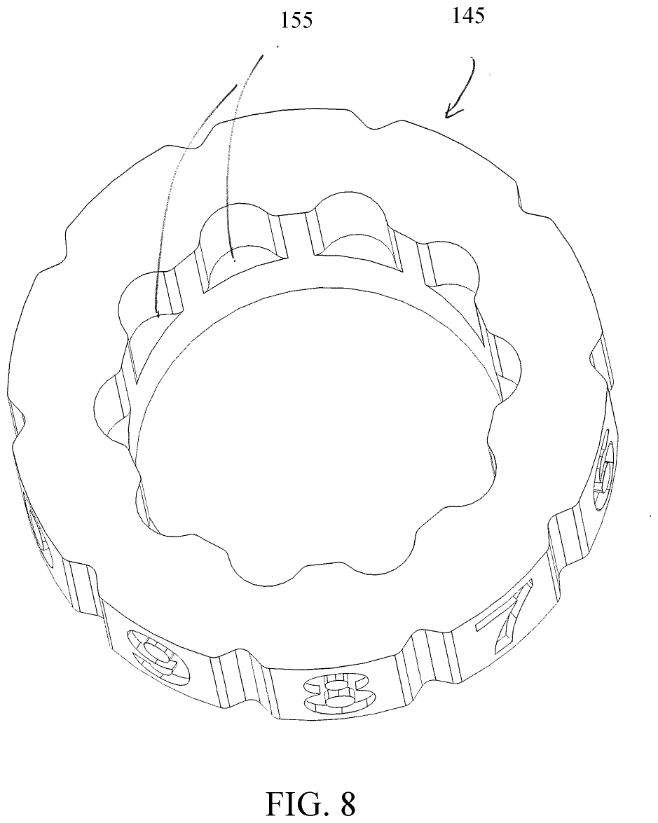

Many different arrangements may be utilized for providing a separate code change position for the locking shaft. As one example, the locking shaft may be rotated (e.g., by rotation of an attached button or knob) from an unlocking position of the shaft to a code change position. As another example, the locking shaft may be moved longitudinally from one of the locked and unlocking positions to a third longitudinal position, for example, by pushing or pulling an attached button. In the illustrated embodiment of FIGS. 1-7, the locking shaft 142 is longitudinally moveable from the unlocked position (FIG. 5) to the code change position (FIG. 6) by sliding the locking shaft 142 beyond the unlocking position by pressing the button 160, thereby aligning the shaft engaging members 141 of each dial subassembly 140 with the corresponding shaft recesses 157. The button 160 may be configured to prevent inadvertent pushing to the code change position, for example, by incorporating a release latch or other secondary operation to permit further pushing. In the illustrated embodiment, the button 160 is rotatable to a code change orientation in which an internal shoulder 162 of the button engages the locking shaft, thereby increasing the longitudinal stroke of the button and shaft when the button is depressed. An outer diameter of the button may include a notch or step 163 engageable with an interior surface of the lock body 110 to positively position the button 160 in the code change orientation. In another embodiment (not shown), the button may be provided with a bayonet or other latching feature to secure the button in the fully pressed, code change position without the user having to continue to press the button during the code change.

To change the combination code of the exemplary padlock 100, the padlock is unlocked, with the shackle 120 automatically moving to the open position, as described above. With the locking shaft 142 retained in the unlocking position, the button 160 is rotated to the code change orientation, and is pushed to longitudinally move the locking shaft into the code change position, thereby aligning the shaft recesses 157 with the shaft engaging members 141. With the button 160 maintained in this fully pushed code change position, the wheels 145 are rotated by the user to orientations corresponding with a desired new unlocking combination code, with the wheel engaging members 148 being fully received in the corresponding hub bores 153 to disengage the wheels 145 from the hubs 143, and the shaft engaging members 141 being pushed radially inward and partially into the shaft recesses 157, such that the hubs 143 are rotationally fixed with the shaft 142. When the new unlocking combination code has been set, the button 160 is released and the locking shaft 142 is returned to the unlocking position, such that the shaft engaging members 141 are forced radially outward from the recesses 157, forcing the wheel engaging members 148 into pockets 155 corresponding with the new unlocking orientations. As shown in FIGS. 4, 5, and 6, ramped surfaces 158 may be provided between the recesses 157 and the longitudinal grooves 152 to facilitate retraction of the shaft engaging members 141 in response to biased movement of the locking shaft 142 from the code change position to the unlocking position. The padlock 100 may then be re-locked, as described above.

In other embodiments, a central shaft about which one or more rotary combination lock elements (e.g., dials, rotating cams) rotate may function as a code change mechanism or component without functioning as a locking component. In one such embodiment, a central shaft is moveable (e.g., longitudinally or rotationally) between a first position in which a wheel engaging member is held in a position rotationally fixing an outer wheel portion of a rotary lock element with an inner hub portion of the rotary lock element, and a second position in which the wheel engaging member is radially moved out of interlocking engagement with one of the outer wheel and the inner hub, such that the inner hub is rotatable with respect to the outer wheel.

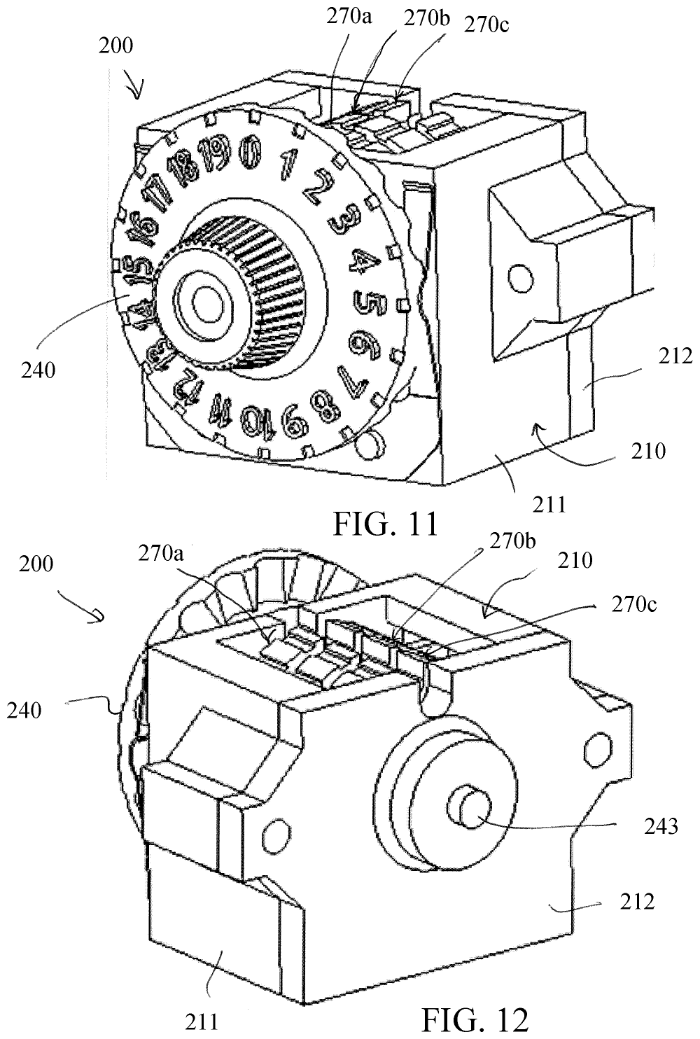

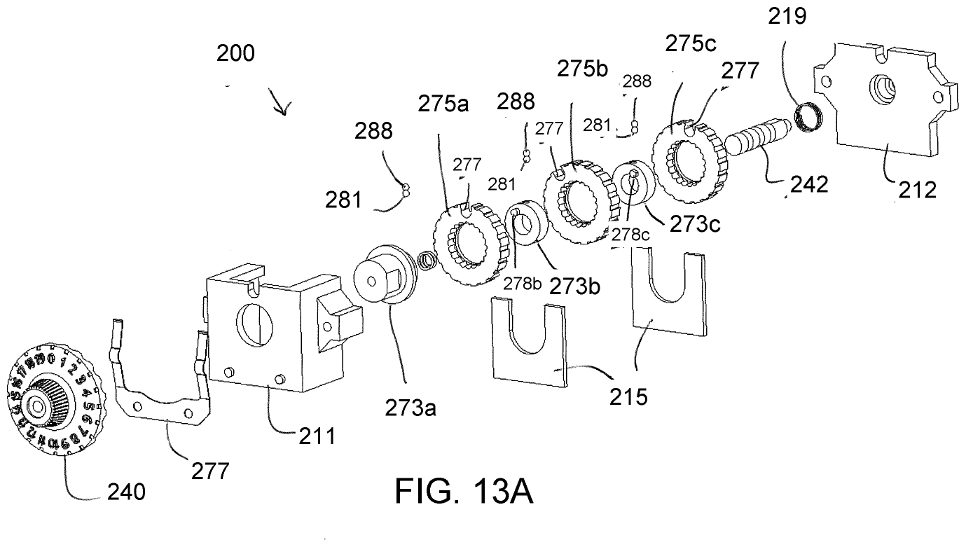

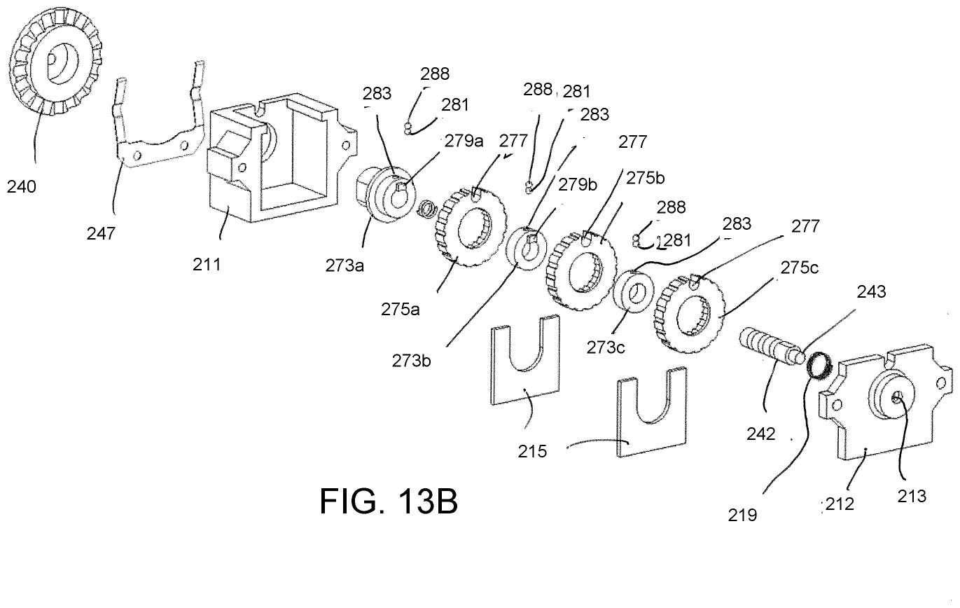

FIGS. 11-15 illustrate an exemplary single dial lock assembly 200, including a single combination dial 240, which serves as the user interface, positioned on an external surface of a lock housing 210, formed from a front casing 211 secured with a rear plate 212 (e.g., by rivets, welding, etc.). The lock 200 may further include a spring detent plate 247 secured between the dial 240 and the front of the lock housing 210 to hold the dial in place in one of several set positions (for example, the numbered “0” through “19” positions on the illustrated dial 240, for alignment with visible indicia on the lock body) when the dials are not being manually rotated by a user.

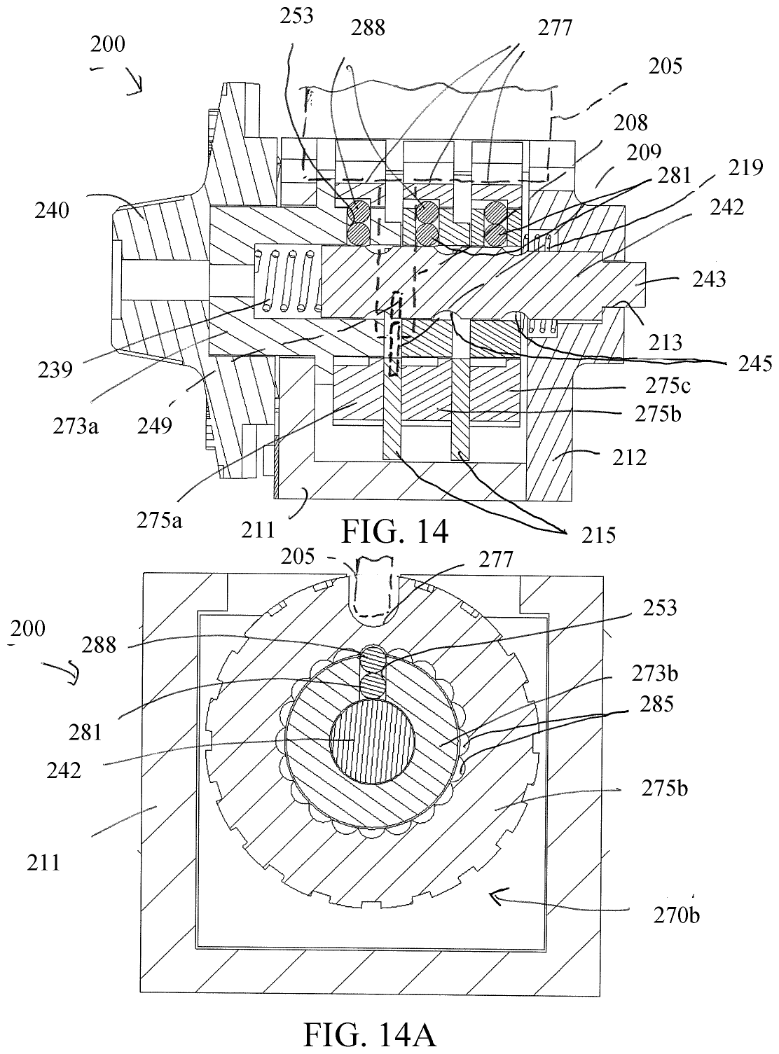

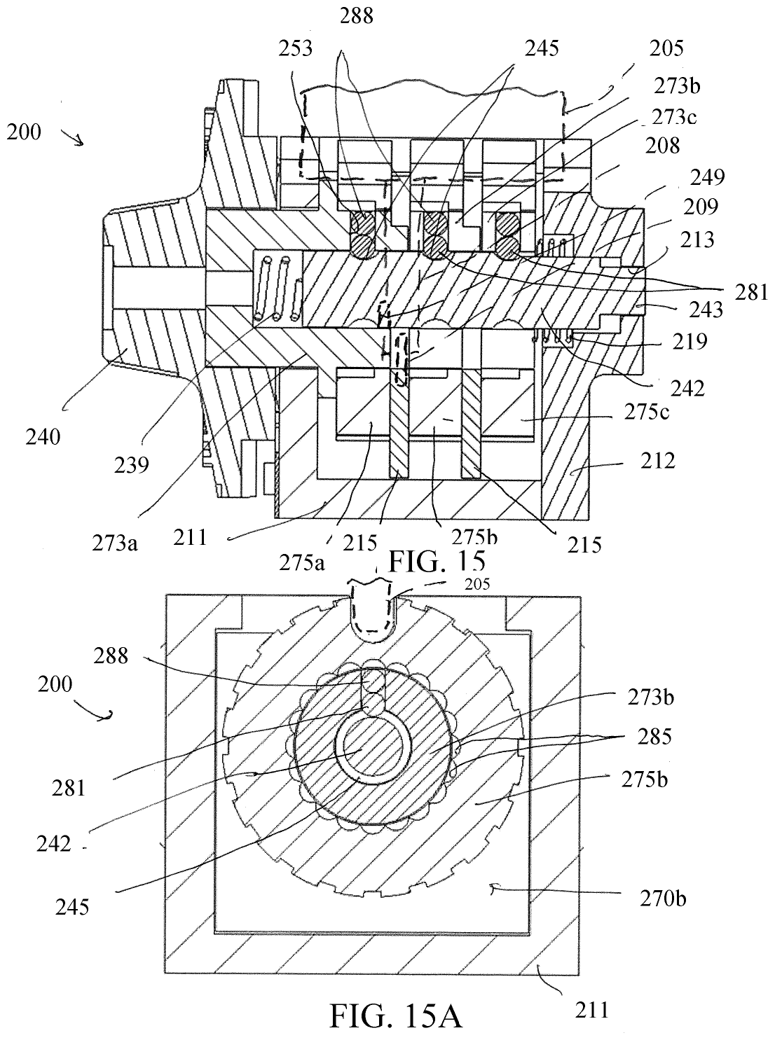

Rotation of the dial 240 causes a first cam or drive cam 270a, rotationally fixed with the dial, to engage a series of two or more rotating cams (e.g., second or middle cam 270b and third or rear cam 270c), each having an outer periphery which holds a latch or blocker (shown schematically at 205 in FIGS. 14, 14A, 15, and 15A) in a locking condition, and an inner periphery which surround a central shaft 242 for rotation about the shaft. Protrusions 279a, 278b, 279b, 278c extending from each of the cams 270a, 270b, 270c engage each other to cause the cams to rotate together. When the dial 240 is rotated to a first rotational position (corresponding with a first code entry identified by alignment of a dial indicium with a marker, not shown) and then rotated in an opposite direction (for example, the counterclockwise direction), the third cam 270c remains in a selected rotational position due to separation of the protrusions 279b, 278c of the second and third cams 270b, 270c. When the dial 240 is then rotated to a second rotational position (corresponding with a second code entry) and then rotated in an opposite direction (for example the clockwise direction), the second cam 270b remains in a selected rotational position due to separation of the protrusions 279a, 278b of the first and second cams 270a, 270b. When the dial 240 is then rotated to a third desired rotational position, the first cam 270a is positioned accordingly. In this fashion, the dial 240 may be rotated to successive desired positions (identified by the indicia on the dial 240) that align notches 277 in each of the cams 270a, 270b, 270c with the latch/blocker 205. When all of the notches are aligned with the latch/blocker, the latch/blocker 205 may be permitted to move into the aligned notches 277 (for example, by user movement or by a spring-loaded mechanism), allowing a locking member (which may be separate from or integral with the notch engaging latch/blocker 205) to move out of locking engagement with a locked obstruction, such as, for example, a shackle, in the case of a combination padlock, or a locker door, in the case of a combination locker lock.

As shown, non-rotating shimming plates 215 may be provided between the cams 270a, 270b, 270c to prevent the cams from engaging each other and inadvertently rotating with each other upon separation of the engaging protrusions. Additionally, a biasing spring 219 may apply a biasing force against the third cam 270c to provide friction resistance to rotation of the second and third cams 270b, 270c.

To provide for changes to the unlocking combination code, each cam 270a, 270b, 270c includes an outer peripheral wheel 275a, 275b, 275c releasably engaged with an inner peripheral hub 273a, 273b, 273c for co-rotation therewith, with the wheels defining the notches 277, and the cams defining the protrusions 278a, 278b, 279b, 278c. While many different arrangements may be utilized to releasably engage the wheels with the hubs, in the illustrated embodiment of FIGS. 11-15, a radially extending bore 283 in each hub 273a, 273b, 273c retains an outer bearing or wheel engaging member 288 and an inner bearing or shaft engaging member 281. The wheel engaging member 288 extends radially outward from the hub bore 283 for engagement with one of a series of pockets 285 around an inner periphery of the wheel 275a, 275b, 275c, to interlock the wheel with the corresponding hub 273a, 273b, 273c when the lock is in the normal locked or unlocking conditions (FIGS. 14 and 14A). To disengage the wheel from the hub, the shaft 242 includes annular grooves or recesses 245 that align with the shaft engaging members 281 when the shaft 242 is longitudinally moved to a code change position. In this code change position (FIGS. 15 and 15A), rotation of the dial 240 (and with it, the hubs 273a, 273b, 273c) pushes the wheel engaging members 288 of each cam 270a, 270b, 270c radially inward into the hub bores 283, and the shaft engaging members 281 radially inward and partially into the shaft recesses 245, such that the wheels 275a, 275b, 275c are disengaged from the hubs 273a, 273b, 273c. In this condition, the wheels 275a, 275b, 275c may be rotationally fixed by engagement of the latch/blocker 205 with the aligned notches 277.

Many different arrangements may be utilized for moving the central shaft from the normal operating position to the code change position. In the illustrated embodiment, an end portion of the shaft 242 extends through an opening 213 in a rear portion 212 of the lock housing 210 to define a code change button 243 that is depressed to move the shaft 242 to the code change position. In some embodiments, such as, for example, locker lock and safe arrangements, the rear portion 212 of the lock housing 210 may only be accessed when the lock assembly 200 is unlocked (e.g., by opening a locker door or safe door). Such arrangements may not require a mechanism preventing actuation of the central shaft 242 when the lock 200 is in a locked condition. In other embodiments, a shaft latch (shown schematically at 209 in FIGS. 14 and 15) may engage a notch 249 in the shaft 242 to block longitudinal movement of the shaft 242, for example, until the latch/blocker 205 is received in the aligned notches 277 of the cams 270a, 270b, 270c, for example, resulting from displacement of the shaft latch 209 by an actuator 208 operatively connected with the latch/blocker 205.

To change the combination code of the exemplary single dial lock 200, the lock is unlocked, with the latch/blocker 205 received in the aligned cam notches 277, and the button 243 is pushed to longitudinally move the shaft 242 into the code change position, thereby aligning the shaft recesses 245 with the shaft engaging members 281. With the button 243 maintained in this pushed code change position, the dial 240 is rotated by the user to rotate the cam hubs 273a, 273b, 273c to orientations corresponding with a desired new unlocking combination code, with the wheel engaging members 288 being fully received in the corresponding hub bores 253 to disengage the wheels 275a, 275b, 275c from the hubs 273a, 273b, 273c, and the shaft engaging members 281 being pushed radially inward and partially into the shaft recesses 245. The latch/blocker 205 may remain engaged with the aligned notches 277 to rotationally fix the wheels 275a, 275b, 275c while the hubs 273a, 273b, 273c are being rotated. When the new unlocking combination code has been set, the button 243 is released and the locking shaft 242 is returned to the normal operating position (e.g., by a biasing spring 239), such that the shaft engaging members 281 are forced radially outward from the recesses 245, forcing the wheel engaging members 288 into pockets 285 corresponding with the new unlocking orientations.

The above described features may be used in combination or incorporation with, other features and embodiments, not specifically shown in the figures but to be understood from the teachings herein. For example, the combination locking mechanism described herein may be used with a different type of lock. For example, the locking shaft may be operatively connected with a locking bolt or latch (e.g., for a safe or locker lock), or a locking cable, staple, or pin. As another example, the locking shaft may form the long leg of a padlock shackle, such that the combination dials rotate around the shackle leg. As another example, a combination locking mechanism may be provided with hubs having a single elongated engaging member replacing the separate wheel engaging and shaft engaging bearings 148, 141 of the embodiment described herein, with a first end of the elongated member extending into interlocking engagement with the wheel when the locking mechanism is in the locked and unlocked conditions, and with the first end retracted into the hub bore for disengagement from the wheel when the locking mechanism is in the code change condition (with a second end of the elongated member engaging a shaft recess in this code change condition).

While various inventive aspects, concepts and features of the inventions may be described and illustrated herein as embodied in combination in the exemplary embodiments, these various aspects, concepts and features may be used in many alternative embodiments, either individually or in various combinations and sub-combinations thereof. Unless expressly excluded herein all such combinations and sub-combinations are intended to be within the scope of the present inventions. Still further, while various alternative embodiments as to the various aspects, concepts and features of the inventions—such as alternative materials, structures, configurations, methods, circuits, devices and components, software, hardware, control logic, alternatives as to form, fit and function, and so on—may be described herein, such descriptions are not intended to be a complete or exhaustive list of available alternative embodiments, whether presently known or later developed. Those skilled in the art may readily adopt one or more of the inventive aspects, concepts or features into additional embodiments and uses within the scope of the present inventions even if such embodiments are not expressly disclosed herein. Additionally, even though some features, concepts or aspects of the inventions may be described herein as being a preferred arrangement or method, such description is not intended to suggest that such feature is required or necessary unless expressly so stated. Still further, exemplary or representative indicators and ranges may be included to assist in understanding the present disclosure; however, such indicators and ranges are not to be construed in a limiting sense and are intended to be critical indicators or ranges only if so expressly stated. Moreover, while various aspects, features and concepts may be expressly identified herein as being inventive or forming part of an invention, such identification is not intended to be exclusive, but rather there may be inventive aspects, concepts and features that are fully described herein without being expressly identified as such or as part of a specific invention, the inventions instead being set forth in the appended claims. Descriptions of exemplary methods or processes are not limited to inclusion of all steps as being required in all cases, nor is the order that the steps are presented to be construed as required or necessary unless expressly so stated.

1. A combination lock comprising:
a lock body;
a locking shaft secured within the lock body;
a plurality of coaxially aligned dials rotatable about the locking shaft, each of the plurality of dials including a user graspable outer peripheral wheel, an inner peripheral hub longitudinally aligned and interlocking with the corresponding wheel, and a shaft engaging ball bearing extending from a radial bore in the hub to engage the locking shaft to block longitudinal movement of the locking shaft, wherein when each of the plurality of dials is rotated to an unlocking orientation, each of the shaft engaging ball bearings is disengageable from the locking shaft to permit longitudinal movement of the locking shaft from a locked position to an unlocking position; and
a code change mechanism configured to disengage each of the plurality of wheels from the corresponding hubs while maintaining longitudinal alignment of the wheels and hubs, to permit rotation of each wheel with respect to the corresponding hub when the locking shaft is in a code change position.

2. The combination lock of claim 1, further comprising a shackle securable with the lock body, and a blocker connected with the locking shaft for movement between a locked position in which the blocker secures the shackle in a closed position, and an unlocking position in which the blocker releases the shackle for movement to an open position.

3. The combination lock of claim 1, further comprising a button depressible to move the locking shaft from the locked position to the unlocking position when each of the plurality of dials is rotated to the unlocking orientation.

4. The combination lock of claim 3, wherein the button is operable to move the locking shaft from the unlocking position to the code change position.

5. The combination lock of claim 1, wherein the code changing mechanism comprises a wheel engaging ball bearing disposed in each of the radial bores extending partially outward of an outer periphery of the hub for engagement with one of a plurality of inner peripheral pockets in the wheel to rotationally fix the wheel with the hub, wherein when the locking shaft is moved to the code change position, the shaft engaging ball bearing of each dial is partially receivable in a corresponding recess in the locking shaft to rotationally fix the corresponding hub with the locking shaft, and the wheel engaging ball bearing is fully receivable into the radial bore to permit rotation of the wheel with respect to the corresponding hub.

6. A combination lock comprising:
a lock body;
a locking shaft secured within the lock body; and
a plurality of coaxially aligned dials rotatable about the locking shaft, each of the plurality of dials including a shaft engaging member received in a corresponding annular groove around the locking shaft to block longitudinal movement of the locking shaft while permitting rotation of the dial around the locking shaft, wherein when each of the plurality of dials is rotated to an unlocking orientation, each of the shaft engaging members aligns with a longitudinal groove in the locking shaft to permit longitudinal movement of the locking shaft with respect to the plurality of dials.

7. The combination lock of claim 6, further comprising a shackle securable with the lock body, and a blocker connected with the locking shaft for movement between a locked position in which the blocker secures the shackle in a closed position, and an unlocking position in which the blocker releases the shackle for movement to an open position.

8. The combination lock of claim 6, further comprising a button depressible to move the locking shaft from the locked position to the unlocking position when each of the plurality of dials is rotated to the unlocking orientation.

9. The combination lock of any of claim 6, wherein each of the plurality of dials includes an inner peripheral hub disposed on the locking shaft, and a user graspable outer peripheral wheel surrounding the hub for rotation of the hub, the wheels being disengageable from the hubs when the locking shaft is moved to a code change position, for rotation of the wheels with respect to the hubs.

10. The combination lock of claim 6, wherein the shaft engaging member comprises a ball bearing.

11. A combination lock comprising:
a lock body;
a locking shaft secured within the lock body; and
a plurality of coaxially aligned dials rotatable about the locking shaft, each of the plurality of dials comprising:
an inner peripheral hub disposed on the locking shaft and including a radial bore extending from an outer periphery of the hub to an inner periphery of the hub;
a user graspable outer peripheral wheel surrounding the hub;
a shaft engaging member disposed in the radial bore and extending partially inward of the inner periphery of the hub for engagement with an annular groove in the locking shaft, to permit rotation of the hub about the locking shaft; and
a wheel engaging member disposed in the radial bore extending partially outward of the outer periphery of the hub for engagement with one of a plurality of inner peripheral pockets in the wheel to rotationally fix the wheel with the hub;
wherein when each of the plurality of dials is rotated to an unlocking orientation, the locking shaft is moveable from a locked position to either one of an unlocking position and a code change position;
wherein when the locking shaft is moved to the code change position, the shaft engaging member of each dial is partially receivable in a corresponding recess in the locking shaft to rotationally fix the corresponding hub with the locking shaft, and the wheel engaging member is fully receivable into the radial bore to permit rotation of the wheel with respect to the corresponding hub.

12. The combination lock of claim 11, further comprising a shackle securable with the lock body, and a blocker connected with the locking shaft for movement between a locked position in which the blocker secures the shackle in a closed position, and an unlocking position in which the blocker releases the shackle for movement to an open position.

13. The combination lock of claim 11, further comprising a button depressible to move the locking shaft from the locked position to the unlocking position when each of the plurality of dials is rotated to the unlocking orientation.

14. The combination lock of claim 13, wherein the button is operable to move the locking shaft from the unlocking position to the code change position.

15. The combination lock of claim 11, wherein the shaft engaging member and the wheel engaging member comprise ball bearings.

16. A combination lock comprising:
a lock body;
a shaft secured within the lock body; and
a plurality of coaxially aligned rotary lock elements rotatable about the shaft, each of the plurality of rotary lock elements comprising:
an inner peripheral hub disposed on the shaft and including a radial bore extending from an outer periphery of the hub to an inner periphery of the hub;
an outer peripheral wheel surrounding the hub;
a shaft engaging member disposed in the radial bore; and
a wheel engaging member disposed in the radial bore extending partially outward of the outer periphery of the hub for engagement with one of a plurality of inner peripheral pockets in the wheel to rotationally fix the wheel with the hub;
wherein when the locking shaft is moved from a normal operating position to a code change position, the shaft engaging member of each dial is partially receivable in a corresponding recess in the locking shaft, and the wheel engaging member is receivable into the radial bore to rotationally disengage the wheel from the corresponding hub.

17. The combination lock of claim 16, wherein the plurality of rotary lock elements comprises a plurality of user rotatable dials.

18. The combination lock of claim 17, further comprising a single user rotatable dial, with the plurality of rotary lock elements comprises a plurality of cams rotatable by user rotation of the single dial.

19. The combination lock of claim 16, wherein the shaft is longitudinally movable from the normal operating position to the code change position.

20. The combination lock of claim 16, wherein the shaft engaging member and the wheel engaging member comprise ball bearings.
